(19) United States
(12) Patent Application Publication
(10) Pub. No.: US 2025/0062489 A1
(43) Pub. Date: Feb. 20, 2025

(54) HIGH VOLTAGE BATTERY AUXILIARY EXHAUST SYSTEM

(71) Applicant: FCA US LLC, Auburn Hills, MI (US)

(72) Inventors: Sreekanth Surapaneni, Oakland, MI (US); Venkata Chagarlamudi, Rochester Hills, MI (US); Uday Mahakali, Novi, MI (US)

(21) Appl. No.: 18/452,013

(22) Filed: Aug. 18, 2023

(51) Int. Cl. H01M 50/358; B60K 6/28; H01M 10/613; H01M 10/625; H01M 10/6566; H01M 50/249

(52) U.S. Cl. CPC H01M 50/358; B60K 6/28; H01M 10/613; H01M 10/625; H01M 10/6566; H01M 50/249; H01M 2220/20

(57) ABSTRACT

A hybrid vehicle that includes an internal combustion engine in communication with an exhaust pipe for expelling exhaust gases generated during use of the internal combustion engine, an electric drive module, a battery pack including a plurality of batteries configured to provide electric power to the electric drive module that includes a housing having a plurality of vents attached thereto for expelling battery exhaust gases, a manifold attached to the housing and configured for receipt of the battery exhaust gases expelled from the plurality of vents, and a duct that connects the manifold to the exhaust pipe and is configured to direct the battery exhaust gases in the manifold to the exhaust pipe.

### FIELD

The present disclosure relates to a vehicle including a high voltage battery auxiliary exhaust system.

### BACKGROUND

This section provides background information related to the present disclosure which is not necessarily prior art.

Vehicles with electric propulsion systems are becoming increasingly more common. Some electrically propelled vehicles include an electric drive motor at each wheel of the vehicle, and some electrically propelled vehicles include a front electric drive motor for rotating the front wheels of the vehicle and a rear electric drive motor for rotating the rear wheels of the vehicle. In either case, the electric drive motors receive power from a battery pack that includes a plurality of battery cells therein. Example battery cells include lithium-ion battery cells and lithium-metal battery cells.

Lithium-ion and lithium-metal battery cells sometimes undergo a process called thermal runaway during failure conditions. Thermal runaway may result in a rapid increase of battery cell temperature accompanied by the release of various gases, which in some cases may be flammable. These flammable gases may be ignited by the high temperature of the battery, which may result in a fire. Accordingly, in the event of a thermal runaway, it is desirable that the vehicle include features that assist in directing the gases in a direction away from the vehicle.

### SUMMARY

This section provides a general summary of the disclosure, and is not a comprehensive disclosure of its full scope or all of its features.

According to a first aspect of the present disclosure, there is provided a hybrid vehicle that includes an internal combustion engine in communication with an exhaust pipe for expelling exhaust gases generated during use of the internal combustion engine; an electric drive module; a battery pack including a plurality of batteries configured to provide electric power to the electric drive module, the battery pack including a housing having a plurality of vents attached thereto for expelling battery exhaust gases; a manifold attached to the housing and configured for receipt of the battery exhaust gases expelled from the plurality of vents; and a duct that connects the manifold to the exhaust pipe and is configured to direct the battery exhaust gases in the manifold to the exhaust pipe.

According to the first aspect, a non-return valve is located between the duct and the exhaust pipe.

According to the first aspect, the non-return valve is a one-way valve that is configured to open at a predetermined pressure.

According to the first aspect, the non-return valve is an electrically operated valve.

According to the first aspect, the hybrid vehicle may also include a controller; and a sensor in communication with the battery pack, wherein the sensor is configured to generate either a signal indicative of a temperature within the battery pack or a signal indicative of a pressure within the battery pack; the controller is in communication with each of the non-return valve and the sensor; and based on the signal indicative of the temperature or the signal indicative of the pressure within the battery pack, the controller is configured to instruct the non-return valve to open.

According to the first aspect, the manifold includes a plurality of cooling vents that are configured to permit ambient air to enter the manifold to intermix with the battery exhaust gases.

According to the first aspect, the plurality of cooling vents are defined by a plurality of apertures formed in a panel of the manifold.

According to the first aspect, the manifold includes a deflector section attached to the housing of the battery pack, and a conduit section that directs the battery exhaust gases to the duct.

According to the first aspect, the duct is formed of a flexible material that is configured to inflate upon receipt of the battery exhaust gases from the manifold.

According to a second aspect of the present disclosure, there is provided a hybrid vehicle that includes an internal combustion engine in communication with an exhaust pipe for expelling exhaust gases generated during use of the internal combustion engine; an electric drive module; a battery pack including a plurality of batteries configured to provide electric power to the electric drive module, the battery pack including a housing having a plurality of vents attached thereto for expelling battery exhaust gases; a first manifold attached to a first end of the housing and configured for receipt of the battery exhaust gases expelled from at least one of the plurality of vents located at the first end of the housing; a second manifold attached to an opposite second end of the housing and configured for receipt of the battery exhaust gases expelled from at least one of the plurality of vents at the opposite second of the housing; a first duct that connect is connected to the first manifold and to the exhaust pipe, the first duct being configured to direct the battery exhaust gases in the first manifold to the exhaust pipe; and a second duct that connect is connected to the second manifold and to the exhaust pipe, the second duct being configured to direct the battery exhaust gases in the second manifold to the exhaust pipe.

According to the second aspect, a first non-return valve is located between the first duct and the exhaust pipe and a second non-return valve is located between the second duct and the exhaust pipe.

According to the second aspect, the non-return valves are each a one-way valve that is configured to open at a predetermined pressure.

According to the second aspect, the non-return valves are each electrically operated valves.

According to the second aspect, the hybrid vehicle may further include a controller; and a sensor in communication with the battery pack, wherein the sensor is configured to generate either a signal indicative of a temperature within the battery pack or a signal indicative of a pressure within the battery pack; the controller is in communication with each of the first and second non-return valves and the sensor; and based on the signal indicative of the temperature or the signal indicative of the pressure within the battery pack, the controller is configured to instruct the first and second non-return valves to open.

According to the second aspect, at least one of the first manifold and the second manifold includes a plurality of cooling vents that are configured to permit ambient air to enter the at least one of the first manifold and the second manifold to intermix with the battery exhaust gases.

According to the second aspect, the plurality of cooling vents are defined by a plurality of apertures formed in a panel of the first manifold or the second manifold.

According to the second aspect, each of the first and second manifolds includes a deflector section attached to the housing of the battery pack, and a conduit section that directs the battery exhaust gases to the first duct and the second duct, respectively.

According to the second aspect, each of the first and second ducts is formed of a flexible material that is configured to inflate upon receipt of the battery exhaust gases from the first and second manifold, respectively.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a vehicle according to a principle of the present disclosure;

FIG. 2 is a perspective view of an example battery pack that may be used in the vehicle illustrated in FIG. 1;

FIG. 3 is a perspective view of the example battery pack illustrated in FIG. 2, and including a manifold; and

FIG. 4 is a perspective view of the manifold illustrated in FIG. 3, and including a plurality of cooling vents.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

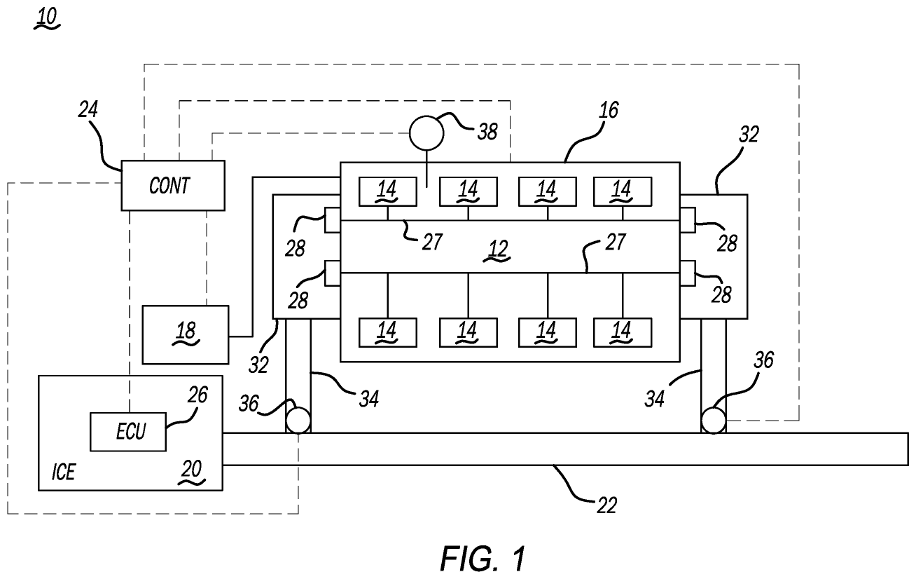

FIG. 1 is a schematic representation of a vehicle 10 according to a principle of the present disclosure. In the illustrated embodiment, vehicle 10 may be an electrically powered vehicle including a battery pack 12 that includes a plurality of battery cells 14. Example battery cells 14 include lithium-ion battery cells, lithium-metal battery cells, and combinations thereof. It should be understood, however, that other types of battery cells 14 known to one skilled in the art may be used, without limitation. Battery pack 12 includes a housing 16 that encases each of the battery cells 14. Housing 16 is preferably formed of a rigid metal material (e.g., steel, aluminum, and the like) that is resistant to puncture and is non-flammable.

Still referring to FIG. 1, an electric drive module 18 is in electrical communication with battery pack 12. Electric drive module 18 may electrically actuate the wheels (not shown) of vehicle 10. While only a single electric drive module 18 is illustrated, it should be understood that vehicle 10 may include a plurality of electric drive modules 18. For example, the front wheels (not shown) of vehicle 10 may be driven by one electric drive module 18, while the rear wheels (not shown) may be driven by another electric drive module 18. Alternatively, each wheel (not shown) may independently be driven by a corresponding electric drive module 12. Regardless of the configuration selected, it should be understood that electric drive module 18 receives a voltage or current from battery pack 12 that is utilized by the electric drive module 18 to drive the wheels of the vehicle 10.

While not required, it should also be understood that vehicle 10 may also include an internal combustion engine (ICE) 20 such that vehicle 10 may be a hybrid electric vehicle. In the event that vehicle 10 is a hybrid electric vehicle including ICE 20, vehicle 10 may also include an exhaust pipe 22 for expelling an exhaust generated during use of ICE 20. Vehicle 10 may include a controller 24 that may communicate with battery pack 12, electric drive module(s) 18, and an electronic control unit (ECU) 26 of ICE 20.

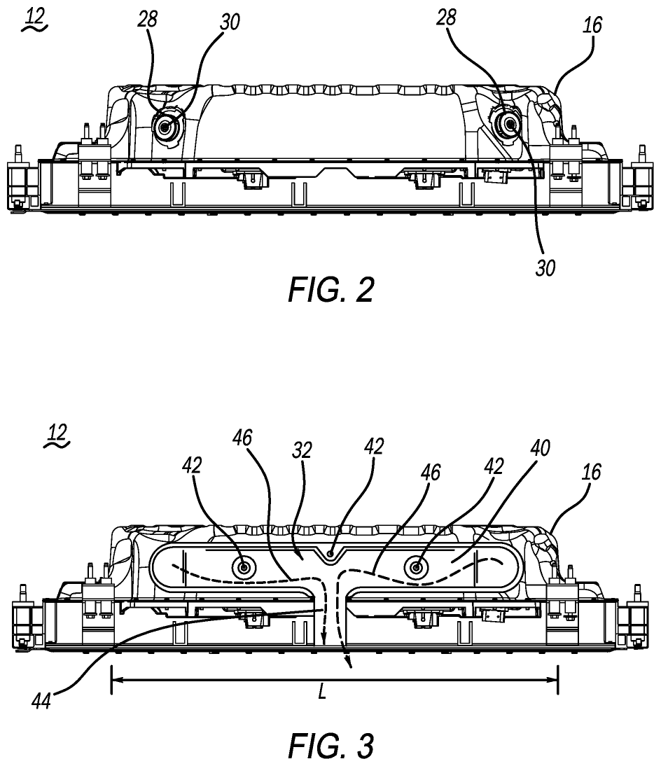

As noted above, battery cells 14 may sometimes undergo a process called thermal runaway during failure conditions of the battery cell(s) 14. Thermal runaway may result in a rapid increase of battery cell temperature accompanied by the release of various gases, which in some cases may be flammable. Example gases that may be released during a thermal runaway event include hydrogen (H₂), carbon monoxide (CO), carbon dioxide (CO₂), and various hydrocarbons including, but not limited to, methane, ethane, ethylene, acetylene, propane, cyclopropane, and butane. As these gases are released and the temperature of battery pack 12 increases, the pressure within battery pack 12 also increases. Housing 16 of battery pack 12, therefore, includes a plurality of vents 28 that permit the pressure and gases to escape housing 16. Vents 28 may each include a valve 30 (see, e.g., FIG. 2) that may be a one-way valve and opens upon a predetermine pressure threshold being generated within housing 16. For example, if the pressure within housing 16 reaches 100 millibars the valves 30 may open and permit the gases within housing 16 to exit the battery pack 12. Vents 28 may be in communication with various conduits 27, which direct the gases generated during the thermal runaway event to the vents 28 to be expelled from battery pack 12.

While housing 16 may include vents 28 including valves 30 for releasing the gases from battery pack 12, the gases released from battery pack 12 may collect beneath the vehicle 10. If the gases are at a sufficient temperature, the gases may combust after exiting battery pack 12 at a location beneath vehicle 10. If this occurs, there is the potential for other features of the vehicle 10 to also combust including, for example, the tires (not shown) of the vehicle 10, hoses (not shown), vehicle brakes (not shown) and other features.

In order to prevent, or at least substantially minimize, the gases from collecting beneath vehicle 10, it should be understood that battery pack 12 may also include a pair of manifolds 32 attached to housing 16 of battery pack 12 and in communication with vents 28 that collect the gases that are generated during the thermal runaway event. Manifolds 32, in turn, are connected to ducts 34 that communicate the gases to exhaust pipe 22 that leads the battery exhaust gases toward a rear of the vehicle 10 away the features of vehicle 10 that can be damaged by the hot battery exhaust gases.

A non-return valve 36 may be positioned in each duct 34 at a location upstream of exhaust pipe 22, which prevents exhaust generated by ICE 20 from entering ducts 34. Non-return valves 36 may be one-way valves that are similar to those used with vents 28 that are opened when a predetermined pressure threshold is reached (e.g., 100 millibars), or non-return valves 36 may be electrically operated (e.g., solenoid) valves that are opened in response to detection of a thermal runaway event. More specifically, a sensor 38 that provides signals indicative of a temperature within battery pack 12 may be in communication with controller 24. If sensor 38 generates a signal indicative of a temperature that corresponds to a thermal runaway event (e.g., 100 degrees C.) that is transmitted to controller 24, controller 24 can communicate an instruction to non-return valves 36 to open to permit the battery exhaust gases to travel from ducts 34 into exhaust pipe 22. Alternatively, sensor 38 may be a pressure sensor configured to generate signals indicative of a pressure within housing 16 of battery pack 12. If sensor 38 generates a signal indicative of a pressure that corresponds to a thermal runaway event (e.g., 100 millibars) that is transmitted to controller 24, controller 24 can communicate an instruction to non-return valves 36 to open to permit the battery exhaust gases to travel from ducts 34 into exhaust pipe 22.

When a thermal runaway event occurs, the gases generated during failure of batteries 14 will enter the various conduits 27 and travel in a direction toward vents 28. As the pressure increases in battery pack 12 and reaches the predetermined threshold (e.g., 100 millibars), valves 30 will open and permit the gases to enter and collect in manifolds 32 before entering ducts 34 and being directed to exhaust pipe 22 where the battery exhaust gases may be expelled into the atmosphere at location away from underneath vehicle 10.

FIG. 3 illustrates battery pack 12 having manifold 32 mounted thereto. Manifold 32 may be formed of a material similar to that of housing 16 (i.e., a rigid metal material (e.g., steel, aluminum, and the like) that is resistant to puncture and is non-flammable). Manifold 32 includes a deflector section 40 that extends along a length L of housing 16 and is rigidly attached to housing 16 at locations 42 using, for example, bolts or some other type of fasteners (not shown). In addition, manifold 32 includes a conduit section 44 connected to deflector section 40 that extends in a downward direction (i.e., towards the ground beneath vehicle 10) from deflector section 40. When comparing FIG. 2 with FIG. 3, it can be seen that deflector section 40 covers discharge vents 28 such that upon gases being released from housing 16 through discharge vents 28, the gases 46 will collect in deflector section 40 and be directed in a direction toward conduit section 44 before being directed by conduit section 44 to ducts 34 (not shown in FIG. 3). While only a single manifold 32 is illustrated, it should be understood that battery pack 12 may include a plurality of manifolds 32 as shown in FIG. 1.

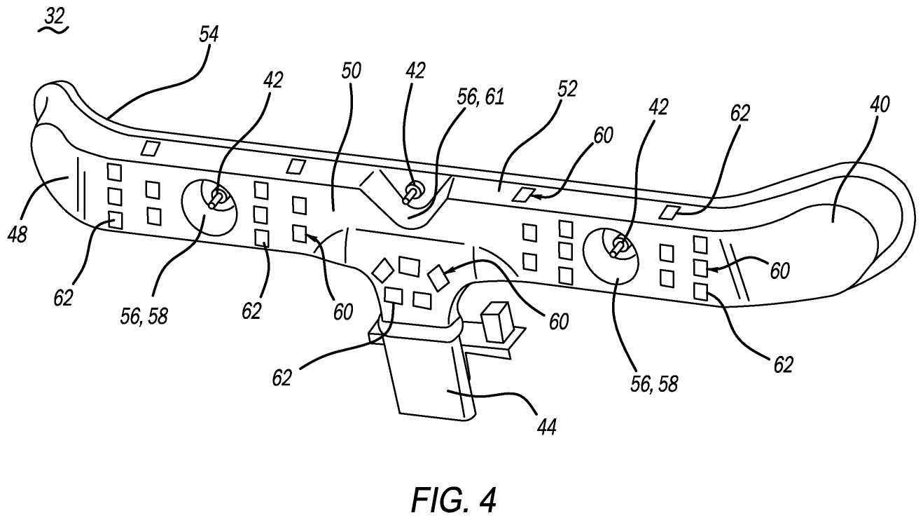

Now referring to FIG. 4, it can be seen that deflector section 40 includes a primary panel 48 having an outer surface 50 that faces away from battery pack 12. A side surface 52 that travels about a perimeter of primary panel 48 connects primary panel 48 to an outwardly extending flange 54 that is configured to mate (i.e., is contoured) with an exterior surface of housing 16. Primary panel 48 may include various flow-deflecting features 56 that are configured to create a turbulent flow within manifold 32. For example, locations 42 where manifold 32 is attached to housing 16 of battery pack 12 may be surrounded by a cup-shaped depression 58 that forces the flow of battery gases generated during a thermal runaway event to flow therearound. In addition, a recess 61 may collectively be formed in side surface 52 and primary panel 48 that directs or deflects the gases in manifold in a direction toward conduit section 44.

Although not required, primary panel 48 and side panel 52 may include a plurality of cooling vents 60 formed therein. The flow-deflecting features 56 assist in intermingling the flow of hot battery exhaust gases with ambient air that may be drawn into manifold 32 through the plurality of the cooling vents 60 that are formed in manifold 32. By drawing ambient air into manifold 32 during a thermal runaway event, the hot battery exhaust gases can be cooled and diluted to assist in preventing, or at least substantially minimizing, the gases that are emitted from exhaust pipe 22 from damaging objects located adjacent to an outlet of exhaust pipe 22.

Cooling vents 60 include an aperture 62 stamped in primary panel 48 and side panel 52 at various locations throughout manifold 32. As the ambient air and hot battery exhaust gases intermix, the hot battery exhaust gases will become diluted with the ambient air and may also significantly reduce in temperature. In this regard, the exhaust gases emitted by battery pack 12 during the thermal runaway event can be at temperatures up to, for example 500 degrees C. The intermixing of the ambient air drawn through apertures 62 with the hot battery exhaust gases can reduce the temperature of the gases to about 300 degrees C. where the mixture of exhaust gases and ambient air exits manifold through conduit section 44, enters ducts 34, and enters exhaust pipe 22. Once the mixture of exhaust gases and ambient air exits exhaust pipe 22 and enters the ambient environment, the temperature can be reduced even further. By reducing the temperature of the exhaust gases, as well as diluting the exhaust gases, the likelihood that the exhaust gases may combust is substantially reduced.

The number of cooling vents 60 for drawing the ambient air into manifold 32 is variable. As shown in FIG. 4, there may be about thirty cooling vents 60 that are formed in manifold. It should be understood, however, that a greater or lesser number of cooling vents 60 may be used as desired. Further, the cooling vents 60 can be arranged in a specific pattern (e.g., groups of five as shown in FIG. 4), or the pattern may be random. The primary aspect to keep in mind regarding the number and arrangement of the cooling vents 60 is the amount of ambient air that can be drawn into manifold to properly treat a temperature of the battery gases as well as properly dilute a concentration of the battery gases. Moreover, while apertures 62 are illustrated as being square or rectangular in shape, it should be understood that apertures 62 can have any shape desired by one skilled in the art including round, oval, triangular, or any other shape.

Ducts 34 that are connected to conduit section 44 of manifold 32. Ducts 32 may be formed of a rigid material such as a metal material, or may be formed of a flexible material. If the material is a flexible material, a material that can be used to form ducts 34 can be a material similar to that used in an airbag. Example materials include high-strength woven materials that retain physical integrity against rapid deployment. The woven material may be coated or uncoated, is impermeable to gases, and flame resistant. Example woven materials include polyamide (e.g., NYLON®), or other woven materials known to those skilled in the art. If such a material is used, non-return valves 36 may be fixed to exhaust pipe 22. If a rigid material is used, non-return valves 36 may be fixed to ducts 34 or to exhaust pipe 22.

If ducts 34 are formed of a material similar to that of an airbag, the weight and cost associated with manufacturing vehicle 10 can be reduced. Moreover, the duct 34 when not in use may lie flat, which provides less packaging requirements for incorporation of ducts 34 into vehicle 10. In the event of thermal runaway and the battery exhaust gases travel from housing 16 to manifold 32 to duct 34, the entry of the gases into ducts 34 can “inflate” ducts 34 to have the profile of a tube or pipe that communicates the exhaust gases to exhaust pipe 22.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A hybrid vehicle comprising:
an internal combustion engine in communication with an exhaust pipe for expelling exhaust gases generated during use of the internal combustion engine;
an electric drive module;
a battery pack including a plurality of batteries configured to provide electric power to the electric drive module, the battery pack including a housing having a plurality of vents attached thereto for expelling battery exhaust gases;
a manifold attached to the housing and configured for receipt of the battery exhaust gases expelled from the plurality of vents; and
a duct that connects the manifold to the exhaust pipe and is configured to direct the battery exhaust gases in the manifold to the exhaust pipe.

2. The hybrid vehicle according to claim 1, wherein a non-return valve is located between the duct and the exhaust pipe.

3. The hybrid vehicle according to claim 2, wherein the non-return valve is a one-way valve that is configured to open at a predetermined pressure.

4. The hybrid vehicle according to claim 2, wherein the non-return valve is an electrically operated valve.

5. The hybrid vehicle according to claim 4, further comprising:
a controller; and
a sensor in communication with the battery pack,
wherein the sensor is configured to generate either a signal indicative of a temperature within the battery pack or a signal indicative of a pressure within the battery pack;
the controller is in communication with each of the non-return valve and the sensor; and
based on the signal indicative of the temperature or the signal indicative of the pressure within the battery pack, the controller is configured to instruct the non-return valve to open.

6. The hybrid vehicle according to claim 1, wherein the manifold includes a plurality of cooling vents that are configured to permit ambient air to enter the manifold to intermix with the battery exhaust gases.

7. The hybrid vehicle according to claim 6, wherein the plurality of cooling vents are defined by a plurality of apertures formed in a panel of the manifold.

8. The hybrid vehicle according to claim 1, wherein the manifold includes a deflector section attached to the housing of the battery pack, and a conduit section that directs the battery exhaust gases to the duct.

9. The hybrid vehicle according to claim 1, wherein the duct is formed of a flexible material that is configured to inflate upon receipt of the battery exhaust gases from the manifold.

10. A hybrid vehicle comprising:
an internal combustion engine in communication with an exhaust pipe for expelling exhaust gases generated during use of the internal combustion engine;
an electric drive module;
a battery pack including a plurality of batteries configured to provide electric power to the electric drive module, the battery pack including a housing having a plurality of vents attached thereto for expelling battery exhaust gases;
a first manifold attached to a first end of the housing and configured for receipt of the battery exhaust gases expelled from at least one of the plurality of vents located at the first end of the housing;
a second manifold attached to an opposite second end of the housing and configured for receipt of the battery exhaust gases expelled from at least one of the plurality of vents at the opposite second of the housing;
a first duct that connect is connected to the first manifold and to the exhaust pipe, the first duct being configured to direct the battery exhaust gases in the first manifold to the exhaust pipe; and
a second duct that connect is connected to the second manifold and to the exhaust pipe, the second duct being configured to direct the battery exhaust gases in the second manifold to the exhaust pipe.

11. The hybrid vehicle according to claim 10, wherein a first non-return valve is located between the first duct and the exhaust pipe and a second non-return valve is located between the second duct and the exhaust pipe.

12. The hybrid vehicle according to claim 11, wherein the non-return valves are each a one-way valve that is configured to open at a predetermined pressure.

13. The hybrid vehicle according to claim 12, wherein the non-return valves are each electrically operated valves.

14. The hybrid vehicle according to claim 13, further comprising:
a controller; and
a sensor in communication with the battery pack,
wherein the sensor is configured to generate either a signal indicative of a temperature within the battery pack or a signal indicative of a pressure within the battery pack;
the controller is in communication with each of the first and second non-return valves and the sensor; and
based on the signal indicative of the temperature or the signal indicative of the pressure within the battery pack, the controller is configured to instruct the first and second non-return valves to open.

15. The hybrid vehicle according to claim 10, wherein at least one of the first manifold and the second manifold includes a plurality of cooling vents that are configured to permit ambient air to enter the at least one of the first manifold and the second manifold to intermix with the battery exhaust gases.

16. The hybrid vehicle according to claim 15, wherein the plurality of cooling vents are defined by a plurality of apertures formed in a panel of the first manifold or the second manifold.

17. The hybrid vehicle according to claim 10, wherein each of the first and second manifolds includes a deflector section attached to the housing of the battery pack, and a conduit section that directs the battery exhaust gases to the first duct and the second duct, respectively.

18. The hybrid vehicle according to claim 10, wherein each of the first and second ducts is formed of a flexible material that is configured to inflate upon receipt of the battery exhaust gases from the first and second manifold, respectively.
